(19) United States
(12) Patent Application Publication
(10) Pub. No.: US 2010/0010866 A1
(43) Pub. Date: Jan. 14, 2010

(54) ADVERTISING ACROSS SOCIAL NETWORK COMMUNICATION PATHWAYS

(75) Inventors: Hrishikesh Bal, Bellevue, WA (US); Michael Waldman Reckhow, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/172,036

(22) Filed: Jul. 11, 2008

(51) Int. Cl. G06Q 30/00; G06Q 10/00

(52) U.S. Cl. 705/10; 705/14.69

(57) ABSTRACT

A method, data structure, and medium are provided for presenting advertisements to users through a social networking web site and tracking the interactions of users with the advertisements. Advertisements describing a product or service can be presented to users of the social networking site along with a plurality of communication options for communicating the advertisement to other users through the social networking site. Upon receiving a selection of a communication option from the user, the advertisement is accordingly communicated to other users through the social networking site. The interactions of those users with the advertisement is then tracked and reported to a third party. The cost of presenting the advertisement can be calculated based on the interactions of users with the advertisement.

### BACKGROUND

Social networking websites allow users to form connections with other users. The connections can be formed, for example, because of a shared interest or background. The social networking websites provide a variety of avenues for users to interact with each other and form or maintain relationships. A user can form or join a social network with other users that share common interests or backgrounds. While some social networking websites display advertisements, the advertisements are often not sufficiently targeted to users in a manner that draws the users' attention to the products and services that are the subject of the advertisements.

### SUMMARY

Embodiments of the present invention relate to a data structure, methods and computer-storage media for generating and presenting advertisements to users through a social networking website. In a first aspect, a data structure embodied on a computer readable medium for storing an advertisement thereon that is delivered to users through a social networking site is provided. The data structure includes a first data field containing information describing a product that is the subject of the advertisement. A second data field is included in the data structure and contains information describing options for distributing the data structure to other users on the social networking site.

In a second aspect, a method for distributing advertisements through a social networking site to users of the social networking site is provided. Information about a product is received that includes an advertisement for the product. The advertisement and communication options are presented to a user. A selection of the communication options is received from the user. The user is able to provide additional information based on the communication option selected. The advertisement and the additional information is then communicated to users on a social networking site based on the selected communication option.

In a third aspect, computer-storage media with instructions embodied thereon for performing a method of tracking the interaction of users with advertisements presented through a social networking site. Information about a product is received that includes an advertisement for the product. The advertisement and communication options are presented to a user. A selection of the communication options is received from the user. The advertisement is then communicated to users on a social networking site based on the selected communication option. Events are captured that relate to the communication of the advertisement to users. The interactions of users with the advertisements are captured as well. The captured events and interactions are communicated to a third party, thereby tracking the interactions of the users with the advertisements.

This Summary is provided to introduce a selection of concepts in a simplified form that are further described below in the Detailed Description. This Summary is not intended to identify key features or essential features of the claimed subject matter nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of a computing system environment suitable for use in implementing embodiments of the present invention;

FIG. 2 is a system diagram illustrating the relationship of social network users to a server in accordance with an embodiment of the invention

FIG. 3 is a system diagram illustrating the relationship of connections between one user and other users in accordance with an embodiment of the invention;

FIG. 4 is a system diagram illustrating a plurality of connections between users in a social network, according to an embodiment of the invention;

FIG. 5 is a diagram illustrating an exemplary advertisement in accordance with an embodiment of the invention;

FIG. 6 is a diagram depicting a data structure for use in implementing embodiments of the present invention;

FIG. 7 is a flow diagram illustrating a method of distributing advertisements through a social networking site to users of the social networking website, according to one embodiment of the invention; and

FIG. 8 is a flow diagram illustrating a method of tracking the interaction of users with advertisements presented through a social networking site.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods and computer-readable media with computer-executable instructions embodied thereon for presenting advertisements to users through a social networking web site and tracking the users interactions with the advertisements. Advertisements describing a product or service can be presented to users of the social networking site along with a plurality of communication options that provide methods of communicating the advertisement to other users through the social networking site. Upon receiving a selection of a communication option from the user, the advertisement is accordingly communicated to other users through the social networking site. The interactions of those users with the advertisement is then tracked and reported to a third party.

Having briefly described an overview of embodiments of the present invention, an exemplary operating environment suitable for use in implementing embodiments of the present invention is described below.

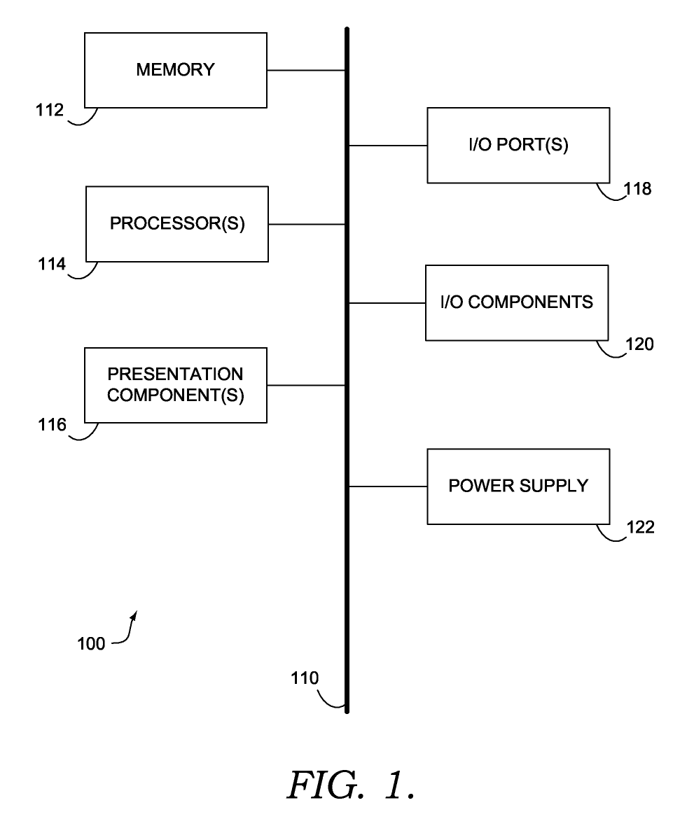

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other hand-held device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty-computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disk drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

Social networking websites allow users to form connections with other users. Examples of social networking websites are FACEBOOK, MYSPACE, and FRIENDSTER, just to name a few. Users create profiles on the social networking web site (hereinafter referred to as a “social networking site”) that include information about the user, such as biographical information, interests, hobbies, or educational information. Included in these profiles can be forms of audio and visual media, either created by the user or obtained from another source. For instance, images of the user can be included in the user's profile.

The connections between users can be formed, for example, because of a shared common interest or activities between a group of users. Users can form connections between one another on both a group and individual basis. For instance, users can associate with one another on an individual basis by a first user issuing a request to a second user to list their status as “friends” or a functional equivalent thereof. When the second user consents to the request, a connection is formed between the first and second users. In effect, this connection is a social network with the first and second users being the only members.

Users can form connections between each other on a group basis as well. Users accomplished this by forming or joining social networks within a social networking site. Specific social networks can be created for a variety of specific interests. Users belonging to a social network are therefore associated with one another. For instance, fans of a particular athletic team or club can form and join a social network for similarly situated individuals. Alumni and alumnae of an educational institution can likewise form and join a social network. Any common interest or similar background can be used as the basis for generating and joining a social network. Further, a single user can belong to multiple social networks within the social networking site and is not limited to being a member of only one social network.

A variety of methods are provided by the social networking websites for users to interact with each other and maintain or form relationships. Examples of these are activity feeds that alert other users when a user in their social network performed an action, such as updating their profile. Users may also send messages to each other, either through methods analogous to email or instant messaging. The profiles of users can also permit other users to post comments to the user's profile.

In accordance with embodiments of the present invention, advertisements are generated for presentation within social networking sites. The advertisements include objective information provided by a promoter of a product or service (e.g., the advertiser) as well as subjective information provided by one or more users of the social networking sites.

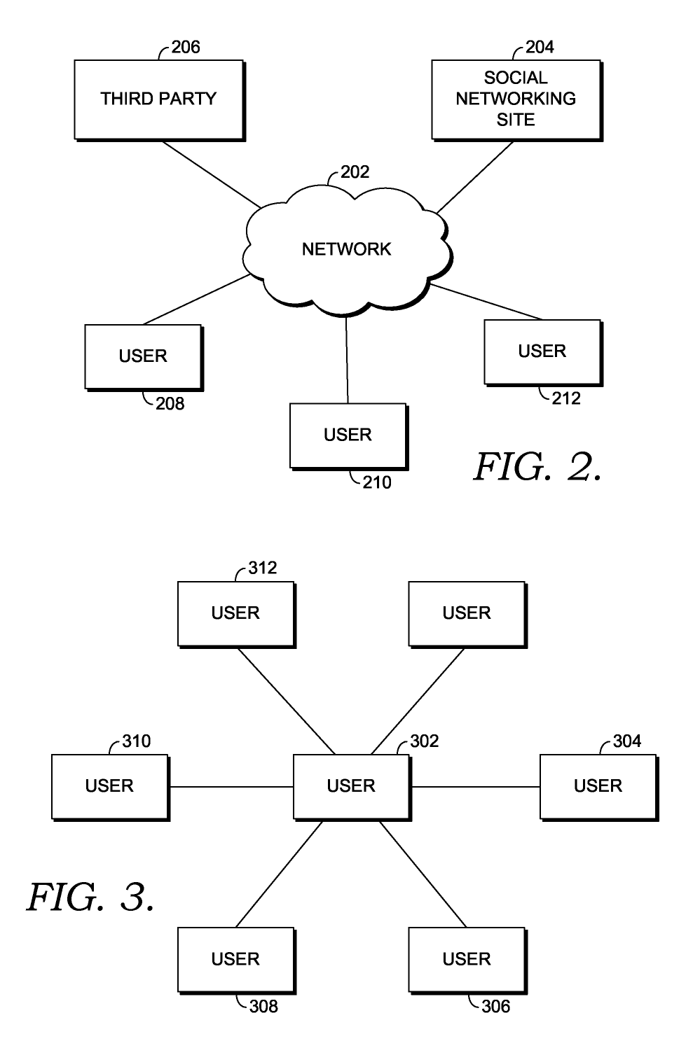

Turning now to FIG. 2, a system diagram illustrating the relationship of social network users to a server is presented in accordance with an embodiment of the invention. The system includes third party 206, social networking site 204, users 208, 210, and 212; all of which are communicatively coupled by network 202. Network 202 can be any type of communications network as is generally known in the art, such as the internet, a local area network (LAN), or a wide area network (WAN).

Users 208, 210, and 212 can be computing devices of the corresponding users and be of the type described in relation to FIG. 1. The social networking site 204 can be of the type described above, such as MYSPACE, FRIENDSTER, or FACEBOOK. The third party 206 can be a server associated with any third party that receives information through the network 202 from the social networking site 204 or the users 208, 210, and 212. This can be information relating to the communication of advertisements to the user 208, 210, and 212 and their subsequent interaction with the advertisements.

Turning now to FIG. 3, a system diagram illustrating the relationship of connection between one user and other users is presented, according to an embodiment of the invention. This diagram depicts a user 302 that is associated with other users 304, 306, 308, 310, 312, and 314 on an individual basis. User 302 can initiate this association or connection on an individual basis by issuing a request to a second user, such as user 304, to list their status as “friends” or a functional equivalent thereof. Upon the second users accepting this request, the users are associated with one another as “friends” or a functional equivalent thereof. This operation can be repeated by the user 302 to associate with other users, such as users 304, 306, 308, 310, 312, and 314.

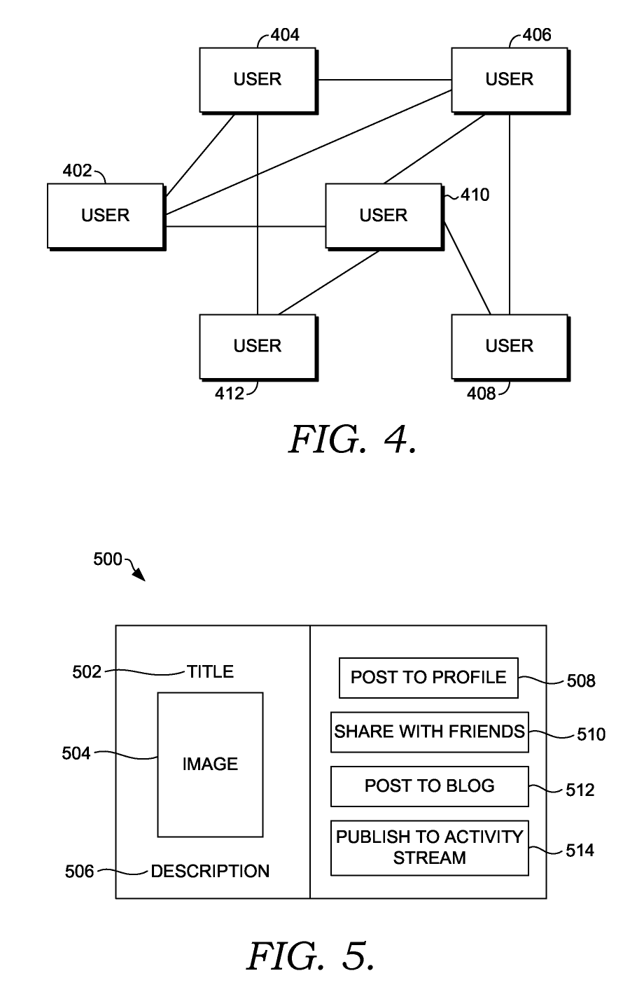

With reference now to FIG. 4, a system diagram illustrating a plurality of connections between users in a social network is presented in accordance with an embodiment of the invention. The diagram depicts users 402, 404, 406, 408, 410, and 412 and their associations with each other. As apparent in FIG. 4, each user can associate with one or more other users. User 402 can initiate this association or connection on an individual basis by issuing a request to a second user, such as user 404, to list their status as “friends” or a functional equivalent thereof. Upon the second users accepting this request, the users are associated with one another as “friends” or a functional equivalent thereof. This operation can be repeated by the user 402 to associate with other users, such as users .404, 406, 408, 410, and 412. In addition, the process can be initiated by any of the users 402, 404, 406, 408, 410, and 412 to establish an association with each other.

Turning to FIG. 5, a diagram depicting an exemplary advertisement is presented, according to an embodiment of the invention. The exemplary advertisement 500 includes information describing the product, such as a title 502 of the product, an image 504 of the product, and a description 506 of the product. Communication options 508, 510, 512, and 514 describe methods of communicating the advertisement 500 to other users through the social networking site. A user can utilize a user input device through their computing device to select one or more of the communication options 508, 510, 512, or 514. A user can effectuate this operation by selecting or clicking with the user input device on the area of the display of the computing device corresponding to the desired communication option.

Additional information can be received from the user through a user input device on their respective computing device. This information can include a message or other form of communication that relates to the product that is the subject of the advertisement. This information can be solicited in response to receiving a selection of communication options 508, 510, 512, and 514. As described above, the selection of one or more communication options can be effectuated through the user input device on the user's respective computing device. Upon receiving a selection of one or more communication options 508, 510, 512, and 514, the user can designate the users that they desire the advertisement to be communicated to. This can be effectuated through the user input device of the computing device.

The communication option 508, 510, 512, and 514 provide different methods for communicating the advertisement 500 to other users through the social networking site. Communication option 508 provides that the advertisement 500 be communicated to other users by posting the advertisement 500 to the user's profile on the social networking site. Other users can then be presented with the advertisement 500 when viewing the user's profile on the social networking site.

Communication option 510 provides that the advertisement 500 is communicated to other users through the social networking site through a message sent by the user. This message can be an email or other similar form of communication that is communicated to other users. When communication option 510 is selected, the user designates other users that they desire to share the advertisement 500 with and additional information to be included with the communication of the advertisement 500. This additional information can include comments by the user regarding the product that is the subject of the advertisement 500. In some embodiments of the invention, the supplying of additional information can be required by the social networking site. In other embodiments, the supplying of additional information can be left to the discretion of the users or not permitted by the social networking site. The advertisement 500 and the additional information, if present, is then communicated through the social networking site to users designated by the user.

Communication option 512 provides that the advertisement 500 be communicated by posting it on a blog maintained by the user. This blog can be of the typical web log variety, and can be contained outside and independent of the social networking site. Alternatively, the blog can be part of the social networking site. Blogs that are part of the social networking site can be referred to as micro-blogs. When the communication option 512 is selected, the user can provide the information necessary to post the advertisement 500 to their blog. As in communication option 510, the user can provide additional information about the product that is the subject of the advertisement 500 that will be posted along with the advertisement 500. After being provided with the information to post the advertisement 500 to the blog, the advertisement and the additional information, if present, is posted to the user's blog. by the social networking site

Communication option 514 provides for the communication of the advertisement 500 to other users through the social networking site by publishing it in the user's activity stream on their profile. The activity stream can be a listing of activities that the user has engaged in on the social networking site. The activities can be the adding of another user as a friend or functional equivalent thereof, the changing of information on the user's profile, or any other information that describes activities engaged in by the user. The activity stream can be communicated to other users that are “friends” of the user. Therefore, the user's “friends” are kept informed of the activities of the user. Upon receiving a selection of communication 514, the advertisement 500, and any additional information that the user submits, is posted to the user's activity stream by the social networking site.

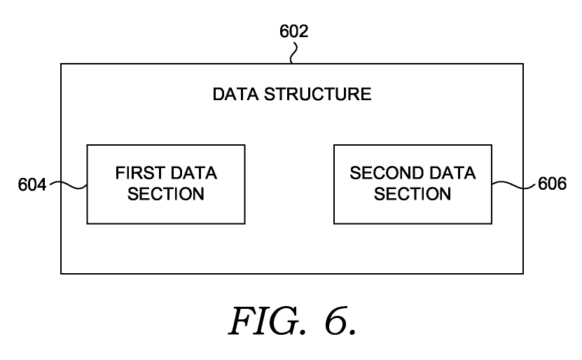

With reference now to FIG. 6, a block diagram depicting a data structure for use in implementing embodiments of the invention is presented. The data structure 602 can be embodied on a computer readable medium for storing information to generate an advertisement to present to one or more users through a social networking site.

Data structure 602 contains a first data section 604 and a section data section 606. First data section 604 contains information describing a product provided by a promoter of the product. A promoter can be a manufacturer of the product, or a retailer selling the product, or any other party that serves to benefit by a sale of the product. This information provided by the promoter can be limited to that which is objective. The information can include the name of the product, a description of the product, an image of the product, and a uniform resource locator (URL) referencing a web site related to the product.

While specific mention is made to a product as being the subject of the advertisement, services could also be the subject of the advertisement, according to embodiments of the present invention.

The data structure 602 also contains a second data section 606. The second data section 606 contains information pertaining to methods of communicating the data structure 602 to users through the social networking site. The methods of communicating the data structure are described in detail in regards to FIG. 5, above. Although not depicted in FIG. 5, a third data field can be provided in the data structure 602. This third data field can include information regarding which of the communication options were selected by the user for the communication of the data structure 602 to other users through the social networking site.

In turn, advertisements may be generated from the data structure 602 and presented to one or more users through the social networking site. The advertisements can be presented by utilizing one of the methods of communication, described above.

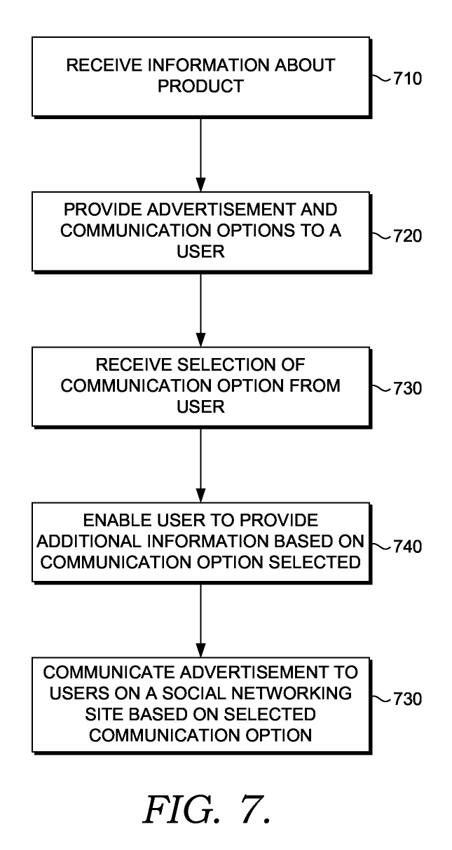

Turning now to FIG. 7, a flow diagram illustrating a method of distributing advertisements through a social networking site to users of the social networking site is presented according to embodiments of the invention. Computer executable instructions embodied on a computer readable medium can be provided for performing the method.

In block 710 information is received about a product. The information can include an advertisement for the product. The information can be received from a promoter of the product and be objective in nature in nature. It can include, for example, a title of the product, an image of the product, and a description of the product. In addition, other information describing the product can be included as well.

In block 720, the advertisement and a plurality of communication options are provided to a user of the social networking site. The plurality of communication options can, according to embodiments of the invention, be presented as a query prompting the user for a selection of one or more of the communication options. The communication options define methods of communicating the advertisement and additional information to other users of the social networking site. The communication options can include the following methods: posting to a profile of the user on the social networking web site, including the advertisement in an email to a contact or friend, posting the advertisement to a blog maintained or created by the user, presenting the advertisement in an activity stream maintained contained in the profile of the user, or updating the status of a micro-blog maintained by the user on the social networking site.

A selection of one or more communication options is received from the user in block 730. The selection can be received by way of a user input device of the user's respective computing device and communicated over the network to the social networking site. Although not depicted in FIG. 7, a selection can be received from the user as to the identities of one or more users to distribute the advertisement to. A variety of methods can be employed to aid in the selection of users to distribute the advertisement to. For example, a user could individually select other users that are “friends” or a functional equivalent thereof, or the user could select to disseminate the advertisement to users that belong to the same network or group as the user.

In block 740, the user is enabled to provide additional information based on the communication option selected in block 730. The additional information can related to the product that is the subject of the advertisement. For example, the additional information could be a description of the user's experience with the product or a rating given by the user to the product. The format of the additional information could be dependent on the particular communication options selected in block 730. For instance, some communication options may only accept additional information in the form of text input, while others may accept audio or video input or ratings.

At block 750, the advertisement and additional information is communicated to users on a social networking site based on the selected communication option. The communication can be effectuated through the social networking site and the network communicatively coupling the computing devices of the users and the social networking site. Upon receiving the advertisement through the social networking site, the other users can then chose to communicate the advertisement to yet other users through the same method described above. In this manner, the advertisement can be rapidly disseminated to a large group of users through the social networking site.

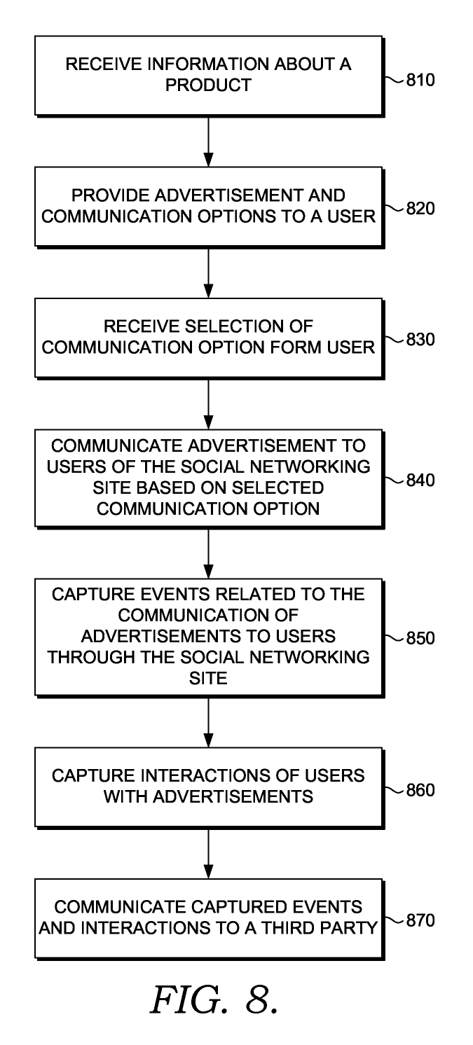

With reference now to FIG. 8, a flow diagram illustrating a method of tracking the interaction of users with advertisements presented through a social networking site is provided according to embodiments of the invention. Computer executable instructions embodied on a computer readable medium can be provided for performing the method.

At block 810, information is received about a product. The information can include an advertisement for the product. The information can be received from a promoter of the product and can be objective in nature in nature. It can include, for example, a title of the product, an image of the product, and a description of the product. In addition, other information describing the product can be included as well. The other information can be provided by users of the social networking site.

In block 820, the advertisement and a plurality of communication options are provided to a user. The communication options define methods of communicating the advertisement and additional information to other users of the social networking site. The communication options can include the following methods: posting to a profile of the user on the social networking web site, including the advertisement in an email to a contact or friend, posting the advertisement to a blog maintained or created by the user, presenting the advertisement in an activity stream maintained contained in the profile of the user, or updating the status of a micro-blog maintained by the user on the social networking site.

In block 840, the advertisement is communicated to users of the social networking site based on the selected communication option. The selection can be received by way of a user input device of the user's respective computing device and communicated over the network to the social networking site. Although not depicted in FIG. 8, a selection can be received from the user as to the identities of one or more users to distribute the advertisement to. A variety of methods can be employed to aid in the selection of users to distribute the advertisement to. For example, a user could individually select other users that are “friends” or a functional equivalent thereof, or the user could select to disseminate the advertisement to users that belong to the same network or group as the user.

At block 850, events are captured relating to the communication of the advertisements to users through the social networking site. These events can be the communication of the advertisement by one user to another user, communication of the advertisement by any of the other communication methods described above, or the number of instances that advertisement is communicated to a particular user or all users.

At block 860, the interactions of the users with the advertisements are captured. The interactions can be the user viewing the advertisement, referred to as an impression, the user clicking on a URL presented in the advertisement and visiting the URL and associated web site, and conversions or acquisitions. Conversion and acquisitions can be instances where the user purchases the product or a related product, subscribed to a service promoted by the advertisement, or takes any other actions that the promoter values. In addition, through the use of browser cookies and other tracking methods, it can be determined if a user purchases the product after viewing the advertisement. This time period could be set at a fixed period, such as 90 days, or it could be indefinite and without a fixed time period.

In block 870, the captured events and interactions are communicated to a third party, thereby tracking the interactions of users with the advertisements. The third party can be the promoter of the product or an advertising server. Based on the captured events and interactions, the cost of providing the advertisement can be calculated and charged to the third party. For instance, a different cost could be assigned to: each communication of the advertisement, each click by a user on the advertisement, and each purchase of the product after a click on the advertisement.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. A data structure embodied on a computer readable medium for storing an advertisement thereon that is delivered to one or more users through a social networking site, the data structure comprising:
a first data field containing information describing a product, wherein the product is the subject of the advertisement; and
a second data field containing information describing one or more communication options for the data structure, wherein the communication options define one or more methods used to distribute the data structure to one or more users on the social networking site.

2. The data structure of claim 1, wherein the information describing the product is provided by a promoter of the product.

3. The data structure of claim 1, wherein the information describing the product comprises: a name of the product, a description of the product, an image of the product, and a uniform resource locator (URL).

4. The data structure of claim 3, wherein the URL references the location of a website related to the product.

5. The data structure of claim 1, wherein the one or more methods used to distribute the data structure comprise: posting to a profile of the user on the social networking site, including the data structure in an email to a contact, posting the data structure to a blog maintained by the user, presenting the data structure in conjunction with an activity stream contained in the user profile of the user on the social networking site, or updating the status of micro-blog maintained by the user.

6. The data structure of claim 1, further comprising a third data field in the data structure for storing a selection of one or more of the distribution options.

7. A method for distributing one or more advertisements through a social networking site to one or more users of the social networking site, the method comprising:
receiving information about a product, wherein the information includes an advertisement for the product;
providing the advertisement and a plurality of communication options to the user, wherein the communication options define methods of communicating the advertisement and additional information to one or more user through the social networking site;
receiving a selection of one or more communication options from the user;
enabling the user to provide additional information based on the selection of one or more communication options; and
communicating the advertisement to the one or more users of the social networking site based on the selected one or more communication options.

8. The method of claim 7, wherein the received information about the product comprises: a name of the product, a description of the product, an image of the product, and a uniform resource locator (URL) of a site related to the product.

9. The method of claim 7, wherein the plurality of communication options are presented to the user in conjunction with the received information about the product.

10. The method of claim 7, wherein the providing of the advertisement and plurality of communication options to the user includes a prompt to the user as to which communication option to implement in distributing the advertisement and other information to the one or more users.

11. The method of claim 10, wherein the communication options comprise the following methods: posting to a profile of the user on the social networking site, including the data structure in an email to a contact, posting the data structure to a blog maintained by the user, presenting the data structure in conjunction with an activity stream contained in the user profile of the user on the social networking site, or updating the status of micro-blog maintained by the user.

12. The method of claim 7, wherein other information includes information received from the user.

13. The method of claim 12, wherein the format of the information received from the user and included in the data structure is dependent on the communication option selected for distributing the advertisement to one or more users.

14. The method of claim 7, further comprising receiving a selection from the user of which of the one or more other users to distribute the advertisement to.

15. The method of claim 14, wherein each of the one or more other users belong to at least one social network in common with the user.

16. The method of claim 14, further comprising presenting the advertisement and other information to the selected one or more users through the social networking site.

17. One or more computer-readable media with computer-executable instructions embodied thereon for performing a method of tracking the interaction of one or more users with one or more advertisements presented through a social networking website, the method comprising:
receiving information about a product, wherein the information includes an advertisement for the product;
providing the advertisement and a plurality of communication options to a user, wherein the communication options define methods of communicating the advertisement and additional information to other users through the social networking site;
receiving a selection of one or more communication options from the user;
communicating the advertisement to one or more users of the social networking site based on the selected communication options;
capturing events relating to the communication of one or more advertisements to one or more users through the social networking site;
capturing the interactions of the one or more users with the one or more advertisements; and
communicating the captured events and interaction to a third party, thereby tracking the interactions of the one or more users with the one or more advertisements.

18. The media of claim 17, wherein the events relating to the communication of the one or more advertisements comprise sharing events where the user selects to communicate one of the one or more advertisements to one or more users.

19. The media of claim 17, wherein the interactions of the one or more users with the one or more advertisements include click events where one of the one or more users to whom the advertisement was communicated clicks on a URL link in the advertisement.

20. The media of claim 17, further comprising calculating the cost of presenting the advertisement based on the captured events or the captured interactions.
